(19) United States
(12) Patent Application Publication
(10) Pub. No.: US 2015/0145711 A1
(43) Pub. Date: May 28, 2015

(54) RETRO-REFLECTIVE RADAR PATCH ANTENNA TARGET FOR VEHICLE AND ROAD INFRASTRUCTURE IDENTIFICATION

(71) Applicant: THE REGENTS OF THE UNIVERSITY OF MICHIGAN, Ann Arbor, MI (US)

(72) Inventors: JOHN M. MADDOX, Ann Arbor, MI (US); William Buller, Dexter, MI (US)

(21) Appl. No.: 14/551,765

(22) Filed: Nov. 24, 2014

Related U.S. Application Data
(60) Provisional application No. 61/908,854, filed on Nov. 26, 2013.

(51) Int. Cl. G01S 13/93

(52) U.S. Cl. CPC G01S 13/931; G01S 2013/9332
USPC 342/27

(57) ABSTRACT

An onboard vehicle detection system for detecting roadway items of interest. The vehicle detection system includes a central controller and a detection system connectable to the vehicle and operably coupled to the central controller. The detection system outputs a detection signal. A target device is connectable to the roadway item of interest and configured to receive the detection signal from the detection system and output a unique return signal to the detection system. The detection system receives the return signal and transfers the return signal for processing to the central controller, whereby the central controller identifies the roadway item of interest and determines a responsive action.

### CROSS-REFERENCE TO RELATED APPLICATIONS

This application claims the benefit of U.S. Provisional Application No. 61/908,854, filed on Nov. 26, 2013. The entire disclosure of the above application is incorporated herein by reference.

### FIELD

The present disclosure relates to vehicle sensing and, more particularly, relates to vehicle and road infrastructure identification using a retro-reflective radar patch antenna target system.

### BACKGROUND AND SUMMARY

This section provides background information related to the present disclosure which is not necessarily prior art. This section provides a general summary of the disclosure, and is not a comprehensive disclosure of its full scope or all of its features.

Current and future vehicles are increasingly incorporating on-board radar systems to enable or aid critical vehicle functions including Adaptive Cruise Control (ACC), Parking Assistance, Forward Collision Warning (FCW), Forward Collision with Active Braking, Blind Spot Warning (BSW) and Lane Keeping Systems (LKS), and others. These technologies provide direct driver assistance in normal driving and critical scenarios, and some are even capable of enhancing driver control or providing autonomous control to prevent or mitigate a crash or negative outcome.

In some cases these radar systems have significant shortcomings in their ability to discern and classify other objects on or near the roadway. For example, radar systems can readily detect and classify moving vehicles, but it is much more difficult to detect and discern stopped vehicles, and other fixed objects. These systems also have difficulty discerning objects adjacent to the roadway, such as bridge abutments, and must therefore be “de-tuned”. Other shortcomings include their inability to discern metallic objects in the roadway such as bridge expansion joints and metal construction plates, which can result in false-positive braking or control applications.

Therefore, it is useful to detect and discern vehicles, roadway objects, and roadside obstructions or items of interest. Therefore, according to the principles of the present teachings, an onboard vehicle detection system for detecting roadway items of interest. The vehicle detection system includes a central controller and a detection system connectable to the forward section of the vehicle and operably coupled to the central controller. The detection system outputs a detection signal. A target device is connectable to the roadway item of interest and configured to receive the detection signal from the detection system and output a unique return signal to the detection system. The detection system receives the return signal and transfers the return signal for processing to the central controller, whereby the central controller identifies the roadway item of interest and determines a responsive action.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a typical tractor-trailer vehicle combination in a potential collision configuration with an adjacent vehicle;

FIG. 2 is a schematic diagram illustrating a tractor-trailer vehicle combination employing the position detection system according to the principles of the present teachings; and

FIG. 3 is a schematic diagram illustrating a Van Atta array design for the retro-reflection patch antenna target according to the principles of the present teachings having an element spacing dependent on the wavelength, λ, for a W-band radar, operating at 77 GHz, λ=3.9 mm.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Many modern vehicles are equipped with onboard radar systems, typically adaptive cruise control systems, forward collision systems, and RF blind-spot detectors, for use as proximity sensors and/or collision detectors. These radar systems output a detection beam whose return signal can be used to detect the presence of obstructions. However, according to the principles of the present teachings, these radar systems, together with reflector systems, can be used to actively detect the position, location, and character of other vehicles, and road-side and roadway objects.

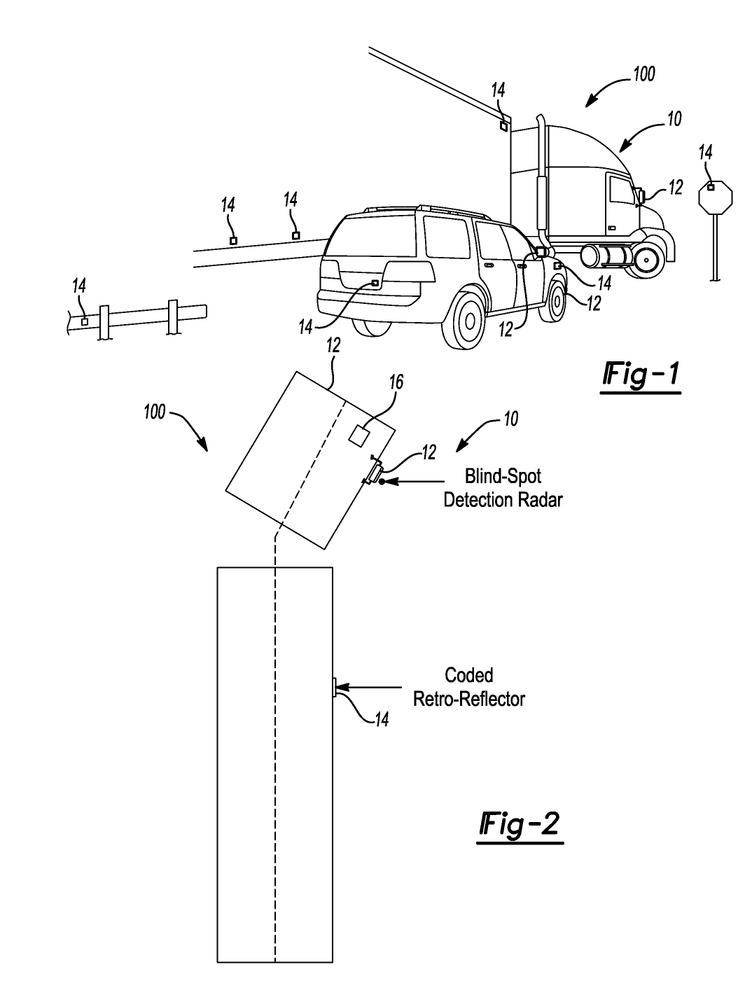

According to the principles of the present teachings and in reference to FIGS. 1-3, a detection system 10 can be provided for use with an existing or add-on radar system 12 that is capable of detecting position and/or distance information from a retro-reflective radar patch antenna target or other target device 14. Detection system 10 can be operably installed on any vehicle equipped with a radar system 12. The patch antenna target 14 would be adhered or installed on a plurality of vehicles and road devices. For example, the patch antenna 14 could be adhered to the rear trunk or hatch of any vehicle, or incorporated into the yearly state registration sticker placed on the license plate. The patch antenna 14 can be detected, as described herein, by radar system 12, which outputs a detection signal to a controller 16. Controller 16 can be used to identify or otherwise discern the object. For instance, based on a unique identification return, controller 16 of detection system 10 could identify the object as a moving car, a stationary abutment or bridge, or other object of interest.

Similarly, patch antenna targets 14 would be adhered or installed on a variety of roadside objects, such as bridge abutments, guardrails, constructions barrels, construction equipment, construction signs, etc. The vehicle-based radar system 12 would process the radar signal reflected off of these devices 14 and their unique signature would allow the vehicle 100 to detect, classify, and therefore avoid, these objects while preventing false positive activations.

It should be understood that variations exists in accordance with the present teachings. For example, it should be understood that a plurality of target devices 14 can be used on vehicle, motorcycle, bicycle, pedestrian, roadway, roadside, and other devices. This can be particularly efficient as the cost of the patch antenna 14 is quite low.

Target device 14 can be configured to employ either polarization or amplitude modulation to distinguish their reflections from other radar reflections in the scene, such as obstructions and/or vehicles. To this end, one can employ a miss-matched filter that correlates reflections with a particular modulation. The term miss-matched is used, because a radar typically looks for reflections of the signal it transmits using a matched-filter.

Enabling Technologies

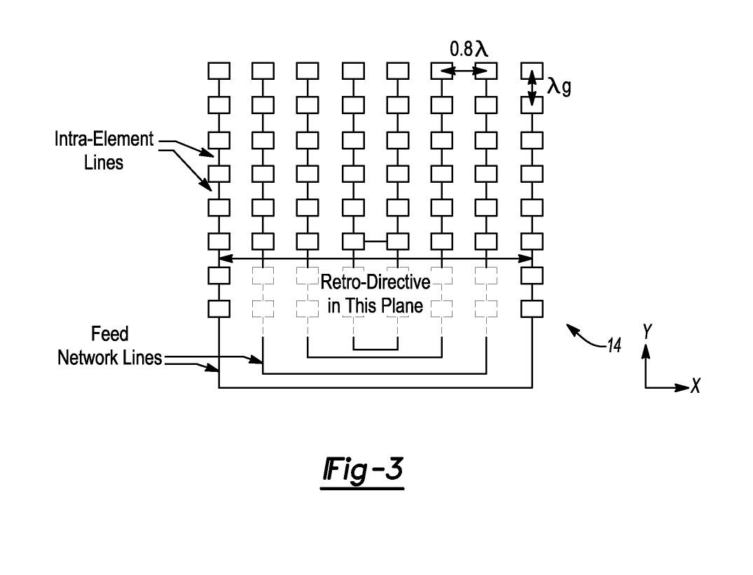

The enabling technologies for this product are the existing blind-spot detection radars 12, and an inexpensive reflecting component 14: van Atta array, or RFID tag. A network of patch antennas, van Atta array (see FIG. 3), can be printed to produce RF retro-reflectors with diode switches to enable signal modulation. As illustrated in FIG. 3, the Van Atta array design for retro-reflection can comprise element spacing dependent on the wavelength, λ. For example, a W-band radar, operating at 77 GHz, would have a λ=3.9 mm.

In automotive applications, the vehicles, roadways and roadside signs, reflect RF waves with the same polarization as transmitted (co-polarization). Therefore, there is an added advantage to enabling the coded retro-reflector to return energy in the cross-polarization channel, to further distinguish its signature. It should be understood that such identification is not simply limited to roadways and roadside signs, but can be used with any items of interest, such as other vehicles, obstructions, speed zones, emergency areas, emergency devices, or anything relevant to a vehicle operator.

RFID tags are commercially available, though typically designed for lower frequencies. However, this is not due to a physical limitation.

There are many applications for retro-reflective antennas as aids to on-board vehicle radar systems. Generally, these inexpensive passive coded retro-reflective antennas could be placed on both moving and stationary objects so that radar-equipped vehicles can positively identify objects to avoid.

For example, current radar systems have difficulty classifying stationary metallic objects, such as bridge abutments, guardrails, and other roadside “furniture”, as well as expansion joints, manhole covers, and other permanent road features. The addition of the coded antenna 14, specific to the type of object, would clearly identify that object as something to avoid entirely, something that can be driven next to, and/or something that can be safely driven over.

Additionally, temporary and semi-permanent deployments of such devices as construction cones and signs, construction trench plates, construction trailers, construction equipment, and even construction personnel, could be equipped with these antennas 14 to identify them as objects to avoid. Maintenance equipment, devices, and personnel could be similarly equipped.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An onboard vehicle detection system for detecting roadway items of interest, said vehicle detection system comprising:
a central controller;
a detection system connectable to the vehicle and operably coupled to said central controller, said detection system outputting a detection signal; and
a target device connectable to the roadway item of interest, said target device being configured to receive said detection signal from said detection system and output a unique return signal to said detection system,
wherein said detection system receives said return signal and transfers said return signal for processing by said central controller, said central controller identifying the roadway item of interest and determining a responsive action.

2. The vehicle detection system according to claim 1 wherein said detection system comprises an onboard collision detection system.

3. The vehicle detection system according to claim 1 wherein said detection system comprises an RF blind-spot detector.

4. The vehicle detection system according to claim 1 wherein said target device comprises an RFID.

5. The vehicle detection system according to claim 1 wherein said target device comprises a patch antenna.

6. The vehicle detection system according to claim 1 wherein said target device comprises a retro-reflective radar patch target.

7. The vehicle detection system according to claim 1 wherein said target device receives said detection signal and outputs a polarized unique return signal.

8. The vehicle detection system according to claim 1 wherein said target device receives said detection signal and outputs an amplitude modulation unique return signal.

9. The vehicle detection system according to claim 1 wherein said target device is a van Atta array target.
